(19) United States
(12) Patent Application Publication
(10) Pub. No.: US 2015/0269891 A1
(43) Pub. Date: Sep. 24, 2015

(54) ELECTROPHORETIC DEVICE AND ELECTRONIC APPARATUS

(71) Applicant: Seiko Epson Corporation, Tokyo (JP)

(72) Inventor: Katsunori Yamazaki, Matsumoto-shi (JP)

(21) Appl. No.: 14/623,816

(22) Filed: Feb. 17, 2015

(30) Foreign Application Priority Data
Mar. 20, 2014 (JP) 2014-058984

(51) Int. Cl. G09G 3/34

(52) U.S. Cl. CPC G09G 3/344; G09G 2310/0275; G09G 2320/02; G09G 2330/021

(57) ABSTRACT

An electrophoretic device includes a pixel that includes a first electrode, a second electrode which is opposite the first electrode, an electrophoretic element which is interposed between the first electrode and the second electrode and includes charged electrophoretic particles, and a pixel circuit which applies a difference in electrical potential between the first electrode and the second electrode; a scan line and a data line that is connected to the pixel circuit; and a first erase circuit that is arranged in a non-display area of the pixel and is a circuit which is connected to the scan line and supplies a erase signal of the pixel to the scan line.

### BACKGROUND

1. Technical Field

The present invention relates to an electrophoretic device and an electronic apparatus.

2. Related Art

A phenomenon (electrophoretic phenomenon) of migration of electrophoretic particles by a Coulomb force is known to occur when an electric field is applied to a dispersion solution made by dispersing electrophoretic particles in a solution. This phenomenon is used to develop an electrophoretic device such as an electronic paper and the like.

These electrophoretic devices include a pixel electrode disposed for each of a plurality of pixels and a common electrode disposed in common opposite a plurality of pixel electrodes and are driven so as to allow electrophoretic particles to migrate using an electric field generated by the difference in electrical potential between the pixel electrode and the common electrode. Then, the state of the electrophoretic particles that migrate according to such a drive method are displayed as a display image in the electrophoretic devices.

To display images in such electrophoretic devices, an image signal is first stored in a memory circuit through a switching element. The difference in electrical potential is generated between the pixel electrode and the opposite electrode when the image signal stored in the memory circuit is directly input to the pixel electrode, and electrical potentials are applied to the pixel electrode. Accordingly, the electrophoretic elements are driven to be capable of displaying images (for example, refer to JP-A-2003-84314). In JP-A-2003-84314, a configuration including a static random access memory (SRAM) (a configuration in which a latch that holds information as electrical potentials in the pixel is incorporated) and a configuration including a dynamic random access memory (DRAM) (a configuration in which a capacitor holds electrical potentials) are disclosed as the memory circuit.

In the above electrophoretic device in the related art, electrophoretic particles gradually remain between the pixel electrodes and the like when the display of images is repeated. This may cause latent images in the display of images. Therefore, latent images can be reduced to obtain a favorable display quality provided that the electrophoretic particles remaining are suppressed by applying an image signal for erase to the pixel electrode. When the image signal for erase is applied to the pixel electrode, the image signal for erase is individually stored in the memory circuit of each pixel electrode through the above-described switching element.

However, a problem arises in that power consumption is increased when obtaining a favorable display quality because parasitic capacitance and the like of the memory circuit consume power when the image signal for erase is stored in the memory circuit.

### SUMMARY

An advantage of some aspects of the invention is to provide an electrophoretic device and an electronic apparatus in which an increase in power consumption is suppressed, and a display quality is favorably obtained.

According to an aspect of the invention, there is provided an electrophoretic device including a pixel that includes a first electrode and a second electrode which is opposite the first electrode, an electrophoretic element which is interposed between the first electrode and the second electrode and includes charged electrophoretic particles, and a pixel circuit which applies a difference in electrical potential between the first electrode and the second electrode; a scan line and a data line that are connected to the pixel circuit; a scan line drive circuit that is connected to the scan line; a first erase circuit that is arranged in a non-display area of the pixel and is a circuit which is connected to the scan line and supplies a erase signal of the pixel to the scan line; a data line drive circuit that is connected to the data line; and a second erase circuit that is arranged in a non-display area of the pixel and is a circuit which is connected to the data line and supplies a erase signal of the pixel to the data line.

In this case, the electrophoretic device supplies the erase signal to the pixel circuit using the first erase circuit and the second erase circuit that are provided separately from the scan line drive circuit and the data line drive circuit. Accordingly, the first erase circuit and the second erase circuit can be designed as a dedicated circuit for supply of the erase signal. Therefore, the erase signal can be efficiently supplied to the pixel circuit compared with a case where the scan line drive circuit and the data line drive circuit supply the erase signal. Thus, this can suppress increase in power consumption.

It is preferable that the first erase circuit include a first erase signal supply line that is connected to each scan line and is a signal supply line of which the number corresponds to the number of scan lines, and the second erase circuit include a second erase signal supply line that is connected to each data line and is a signal supply line of which the number corresponds to the number of data lines.

In this case, the electrophoretic device simultaneously supplies the erase signal to a plurality of scan lines or a plurality of data lines. Accordingly, the number of operations of supplying the erase signal to the pixel circuit can be decreased. Thus, this can further suppress the increase in power consumption.

It is preferable that at least one of the first erase circuit and the second erase circuit supply the erase signal of a pattern that is selected from a plurality of predetermined patterns of the erase signal.

In this case, the electrophoretic device selects the erase signal from a predetermined pattern of the erase signal and supplies the erase signal to the pixel circuit. Accordingly, the electrophoretic device can shorten a time for supplying the erase signal to the pixel circuit compared with a case where the erase signal is sequentially read from a circuit that stores the erase signal or a case where the erase signal is sequentially generated.

It is preferable that at least one of the first erase circuit and the second erase circuit generate a pattern of the erase signal and supply the pattern of the erase signal generated.

In this case, the electrophoretic device generates the pattern of the erase signal and supplies the erase signal generated to the pixel circuit. A erase signal pattern generation circuit can be configured of a simple logic circuit. Accordingly, the erase circuit in the electrophoretic device can be miniaturized.

According to another aspect of the invention, there is provided an electronic apparatus including the electrophoretic device.

In this case, the electronic apparatus can efficiently supply the erase signal to the pixel circuit compared with a case where the scan line drive circuit and the data line drive circuit supply the erase signal. Thus, this can suppress the increase in power consumption.

As described above, according to the invention, the electrophoretic device and the electronic apparatus each can efficiently supply the erase signal to the pixel circuit. Thus, this can suppress the increase in power consumption and prevent latent images.

### BRIEF DESCRIPTION OF THE DRAWINGS

The invention will be described with reference to the accompanying drawings, wherein like numbers reference like elements.

FIG. 1 is a block diagram illustrating the schematic configuration of an electrophoretic device according to an embodiment of the invention.

FIG. 2 is a timing diagram illustrating an example of the operation of a scan line drive circuit.

FIG. 3 is a timing diagram illustrating an example of the operation of a data line drive circuit.

FIGS. 4A and 4B are block diagrams illustrating an example of the circuit configuration of a scan line side erase circuit and a data line side erase circuit.

FIG. 5 is a block diagram illustrating an example of the circuit configuration of a pixel.

FIGS. 6A and 6B are schematic diagrams illustrating an example of the configuration of a display unit.

FIGS. 7A and 7B are schematic diagrams illustrating an example of the operation of an electrophoretic element.

FIG. 8 is a timing diagram illustrating an example of the operation of the electrophoretic element.

FIG. 9 is a schematic diagram illustrating an example of a latent image.

FIGS. 10A to 10C are schematic diagrams illustrating an example of erase by using a erase pattern.

FIG. 11 is a timing diagram illustrating an example of the erase operation of the electrophoretic element.

FIG. 12 is a timing diagram illustrating a modification example of the erase operation of the electrophoretic element.

FIGS. 13A and 13B are block diagrams illustrating a modification example of the circuit configuration of the scan line side erase circuit and the data line side erase circuit.

FIGS. 14A to 14C are diagrams illustrating an example of an electronic apparatus.

FIG. 15 is a block diagram illustrating a modification example of the scan line side erase circuit.

### DESCRIPTION OF EXEMPLARY EMBODIMENTS

Embodiments of the invention will be described in detail with reference to the accompanying drawings.

### Electrophoretic Device

Hereinafter, embodiments of the invention will be described with reference to the accompanying drawings. The present embodiment illustrates an aspect of the invention, not limiting the invention and thus may be arbitrarily modified within the range of the technical idea of the invention. In addition, to make each configuration understood easily, the scale or the number of constituents in each structure in the drawings below is made differently from that of the actual structure.

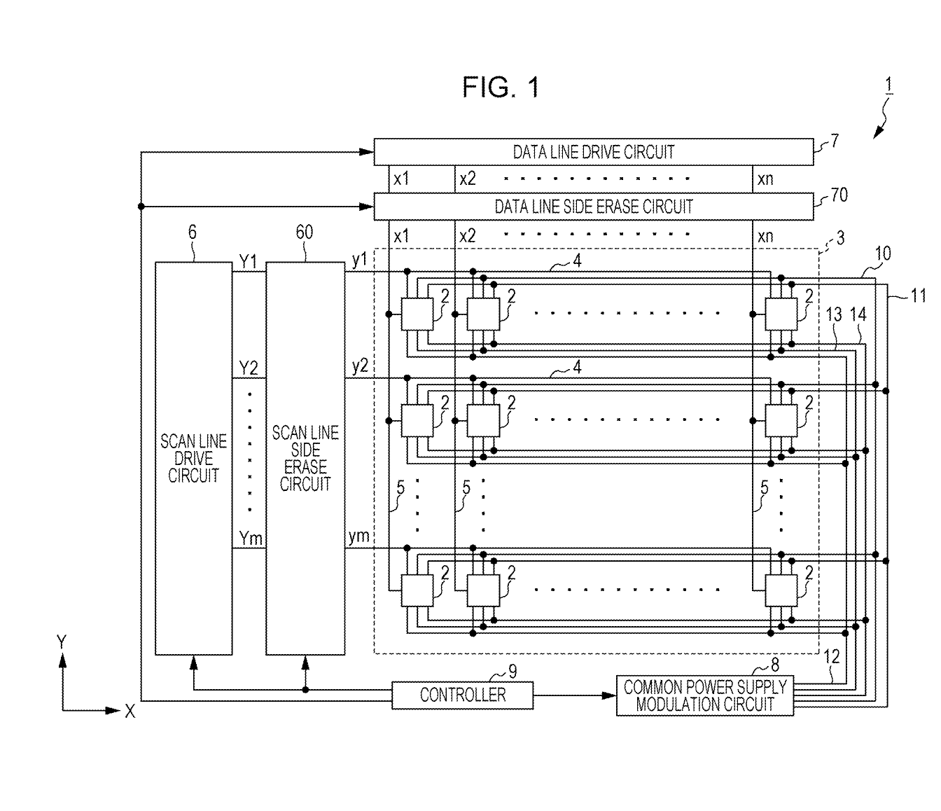

FIG. 1 is a block diagram illustrating the schematic configuration of an electrophoretic device 1 according to an embodiment of the invention. In FIG. 1, an active-matrix electrophoretic device is illustrated as an example in the present embodiment. The electrophoretic device 1 illustrated in FIG. 1 includes a display unit 3 in which a plurality of pixels 2 is arranged in a matrix shape and includes a scan line drive circuit 6, a scan line side erase circuit 60, a data line drive circuit 7, a data line side erase circuit 70, a common power supply modulation circuit 8, and a controller 9 in the vicinity of the display unit 3.

The pixels 2 are arranged in the display unit 3 having m pixels along the Y axis direction and n pixels along the X axis direction. Each pixel 2 in the display unit 3 is arranged at the intersection position of a plurality of scan lines 4 that extends from the scan line drive circuit 6 and a plurality of data lines 5 that extends from the data line drive circuit 7.

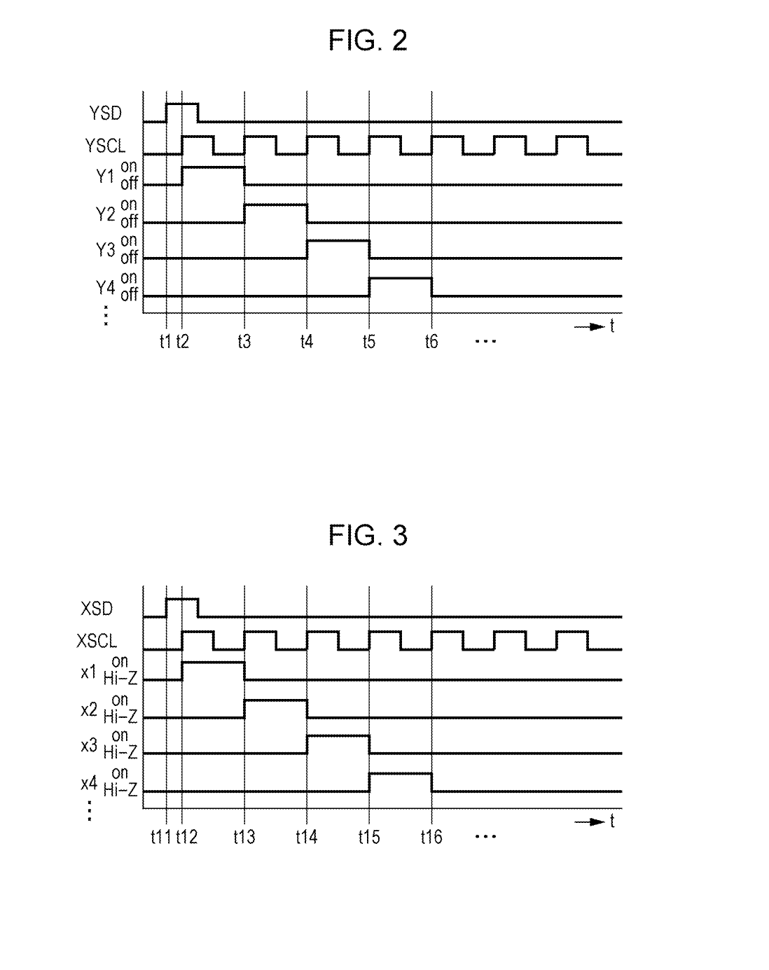

The scan line drive circuit 6 outputs a selection signal for selecting the pixel 2 that is specified by the controller 9 to each row of the pixel 2 arranged in the X axis direction (row direction) of the display unit 3. When outputting the selection signal, the scan line drive circuit 6 outputs the selection signal sequentially to a plurality of signal supply lines (Y1, Y2, . . . , Ym) wired along the X axis direction of the display unit 3 as illustrated in FIG. 2.

FIG. 2 is a timing diagram illustrating an example of the operation of the scan line drive circuit.

The scan line drive circuit 6 is configured of a shift register circuit. The scan line drive circuit 6 obtains a scan start signal YSD at the rise of a shift clock signal YSCL and performs a shift operation sequentially. The scan line drive circuit 6 outputs the result of performance of the shift operation as the selection signal to the scan line side erase circuit 60 through the signal supply lines (Y1, Y2, . . . , Ym). The selection signal is formed of electrical potentials having two values. Higher electric potentials are described as “1”, and lower electric potentials are described as “0” hereinafter.

In the present embodiment, electrical potentials of the scan line 4 are set to “1” when selecting the pixel 2, and electrical potentials of the scan line 4 are set to “0” when not selecting the pixel 2.

The scan line drive circuit 6 is described as obtaining the scan start signal YSD on the rising edge of the shift clock signal YSCL in this example, but this does not limit the scan line drive circuit 6. The scan line drive circuit 6 may obtain the scan start signal YSD on the falling edge of the shift clock signal YSCL or may perform the shift operation on both edges of the shift clock signal YSCL.

The data line drive circuit 7 outputs image data input from the controller 9 to a plurality of data lines (x1, x2, . . . , xn) wired along the Y axis direction of the display unit 3 for each column of the pixel 2 arranged in the Y axis direction (column direction) of the display unit 3 as illustrated in FIG. 3.

FIG. 3 is a timing diagram illustrating an example of the operation of the data line drive circuit 7.

The data line drive circuit 7 is configured of a shift resister circuit. The data line drive circuit 7 obtains a scan start signal XSD at the rise of a shift clock signal XSCL and performs a shift operation sequentially. The data line drive circuit 7 performs the shift operation and selects the data lines (x1, x2, . . . , xn) sequentially. The data line 5 selected outputs the image data transferred from the controller 9 to the display unit 3 (pixel 2) synchronized with the shift operation. Meanwhile, the other data lines 5 not selected are in a high-impedance state (Hi-Z). Electrical potentials of the data line 5 are formed of electrical potentials having two values. Higher electrical potentials are described as “1”, and lower electrical potentials are described as “0” hereinafter.

In the present embodiment, electrical potentials of the data line 5 are set to “0” when image data “0” is written into the pixel 2, and electrical potentials of the data line 5 are set to “1” when image data “1” is written into the pixel 2.

The data line drive circuit 7 is described as obtaining the scan start signal XSD on the rising edge of the shift clock signal XSCL in this example, but this does not limit the data line drive circuit 7. The data line drive circuit 7 may obtain the scan start signal XSD on the falling edge of the shift clock signal XSCL or both edges of the shift clock signal XSCL.

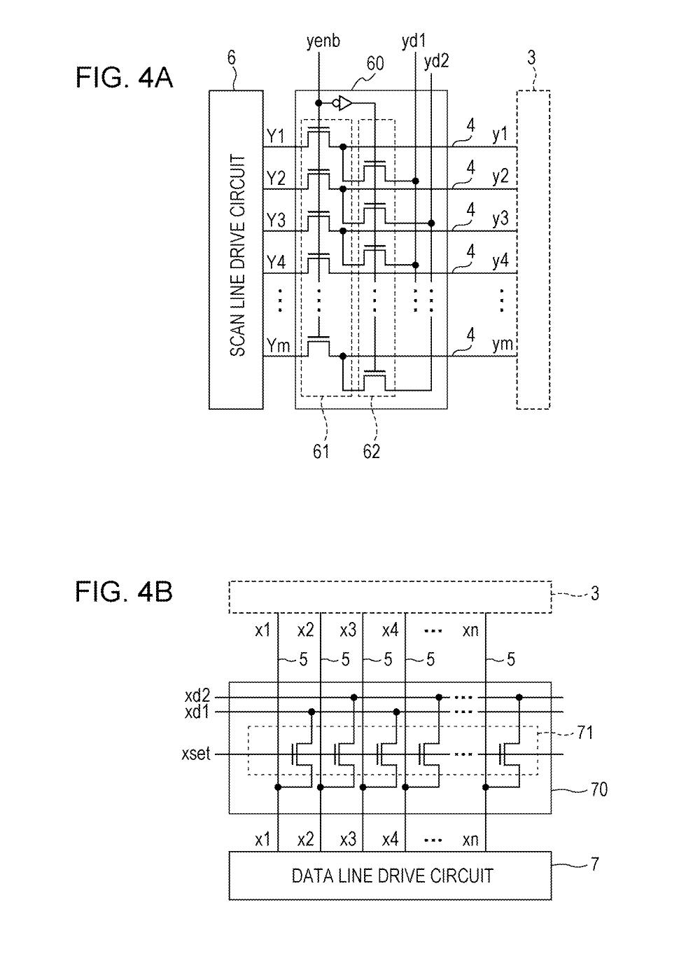

Next, the configuration of the scan line side erase circuit 60 and the data line side erase circuit 70 will be described with reference to FIGS. 4A and 4B.

FIGS. 4A and 4B are block diagrams illustrating an example of the configuration of the scan line side erase circuit 60 and the data line side erase circuit 70.

First, the configuration of the scan line side erase circuit 60 will be described with reference to FIG. 4A. The scan line side erase circuit 60 is connected to the scan line drive circuit 6 by the signal supply lines (Y1 to Ym) and is connected to each pixel 2 of the display unit 3 by the scan lines 4 (y1 to ym). That is, the scan line side erase circuit 60 is a circuit that is connected to the scan line 4 and supplies a erase signal of the pixel 2 to the scan line 4. The scan line side erase circuit 60 is arranged in a non-display area of the pixel 2 so as not to hinder display by the display unit 3. In addition, the scan line side erase circuit 60 is connected to the controller 9 and is supplied with a switch signal yenb, a first selection voltage yd1, and a second selection voltage yd2 from the controller 9. The scan line side erase circuit 60 includes a first transistor 61 and a second transistor 62 as a switch that switches between an ON state and an OFF state in response to the voltage of the switch signal yenb.

The first transistor 61 is connected to the signal supply lines (Y1 to Ym) and the scan lines 4 (y1 to ym). That is, signal supply lines (first erase signal supply line) of which the number corresponds to the number of the scan lines 4 are included in the scan line side erase circuit 60 connected respectively to the scan lines 4. The first transistor 61 is in the ON state when the switch signal yenb is “1” and is in the OFF state when the switch signal yenb is “0”. The selection signal supplied from the signal supply lines (Y1 to Ym) is output to the scan lines 4 (y1 to ym) when the first transistor 61 is in the ON state. Meanwhile, the selection signal supplied from the signal supply lines (Y1 to Ym) is not output to the scan lines 4 (y1 to ym) but blocked when the first transistor 61 is in the OFF state.

The second transistor 62 is connected to a supply line of the first selection voltage yd1 or a supply line of the second selection voltage yd2 and is connected to the scan lines 4 (y1 to ym). In this example, the supply line of the first selection voltage yd1 is connected to the second transistor 62 that is connected to the scan line 4 in the odd-numbered rows (y1, y3, . . . ) among the second transistors 62. In addition, the supply line of the second selection voltage yd2 is connected to the second transistor 62 that is connected to the scan line 4 in the even-numbered rows (y2, y4, . . . ) among the second transistors 62.

The second transistor 62 is in the OFF state when the switch signal yenb is “1” and is in the ON state when the switch signal yenb is “0”. The first selection voltage yd1 or the second selection voltage yd2 is output to the scan lines 4 (y1 to ym) when the second transistor 62 is in the ON state. Meanwhile, the first selection voltage yd1 or the second selection voltage yd2 is not output to the scan lines 4 (y1 to ym) but blocked when the second transistor 62 is in the OFF state.

That is, the first transistor 61 is in the ON state, and the second transistor 62 is in the OFF state when the switch signal yenb is “1”. Accordingly, the selection signal supplied from the signal supply lines (Y1 to Ym) is output to the scan lines 4 (y1 to ym) as it is. Meanwhile, the first transistor 61 is in the OFF state, and the second transistor 62 is in the ON state when the switch signal yenb is “0”. Accordingly, the first selection voltage yd1 is output to the scan line 4 in the odd-numbered row, and the second selection voltage yd2 is output to the scan line 4 in the even-numbered row.

Here, the controller 9 can switch the voltages of the first selection voltage yd1 and the second selection voltage yd2 supplied to the scan line side erase circuit 60. Specifically, the controller 9 sets the first selection voltage yd1 to “1” and the second selection voltage yd2 to “0” as a first state. In addition, the controller 9 sets the first selection voltage yd1 to “0” and the second selection voltage yd2 to “1” as a second state.

Accordingly, the scan line side erase circuit 60 outputs “1” as the selection signal to the scan line 4 in the odd-numbered row when the switch signal yenb of “0” is supplied to the scan line side erase circuit 60 in the first state. That is, the scan line side erase circuit 60 supplies the erase signal that has a pattern selected from a plurality of predetermined erase signal patterns. Accordingly, the pixel 2 in the odd-numbered row is selected. In addition, the scan line side erase circuit 60 outputs “1” as the selection signal to the scan line 4 in the even-numbered row when the switch signal yenb of “0” is supplied to the scan line side erase circuit 60 in the second state. Accordingly, the pixel 2 in the even-numbered row is selected.

The selection signal that the scan line side erase circuit 60 outputs is output to the plurality of scan lines 4 (y1, y2, . . . , ym) wired along the X axis direction of the display unit 3 through the scan line side erase circuit 60. Electrical potentials of the data line 5 output from the data line drive circuit 7 are written into the pixel 2 that is selected by the selection signal.

Next, the configuration of the data line side erase circuit 70 will be described with reference to FIG. 4B. The data line side erase circuit 70 is a circuit that is connected to the data line drive circuit 7, is connected to each pixel 2 of the display unit 3 by the data lines 5 (x1 to xn), and supplies the erase signal of the pixel 2 to the data line 5. The data line side erase circuit 70 is arranged in the non-display area of the pixel 2 so as not to hinder display by the display unit 3. In addition, the data line side erase circuit 70 is connected to the controller 9 and is supplied with a switch signal xset, a first data voltage xd1, and a second data voltage xd2 from the controller 9. The data line side erase circuit 70 includes a switch transistor 71 as a switch that switches between an ON state and an OFF state in response to the voltage of the switch signal xset.

The switch transistor 71 is connected to a supply line of the first data voltage xd1 or the second data voltage xd2 and is connected to the data lines 5 (x1 to xn). In this example, the supply line of the first data voltage xd1 is connected to the switch transistor 71 that is connected to the data line 5 in the odd-numbered columns (x1, x3, . . . ) among the switch transistors 71. In addition, the supply line of the second data voltage xd2 is connected to the switch transistor 71 that is connected to the data line 5 in the even-numbered columns (x2, x4, . . . ) among the switch transistors 71. The switch transistor 71 is in the ON state when the switch signal xset is “1” and is in the OFF state when the switch signal xset is “0”. When the data line drive circuit 7 does not output the image data (when all the levels in the shift resister circuit are “0”), all the output terminals of the data line drive circuit are in the high-impedance state (Hi-Z), and all the data lines are in the high-impedance state (Hi-Z). The first data voltage xd1 or the second data voltage xd2 is output to the data lines 5 (x1 to xn) when the output terminal of the data line drive circuit 7 is in the high-impedance state (Hi-Z), and the switch transistor 71 is in the ON state.

Here, the controller 9 can switch the voltages of the first data voltage xd1 and the second data voltage xd2 supplied to the data line side erase circuit 70. Specifically, the controller 9 sets the first data voltage xd1 to “1” and the second data voltage xd2 to “0” as a first state. In addition, the controller 9 sets the first data voltage xd1 to “0” and the second data voltage xd2 to “1” as a second state.

Accordingly, the data line side erase circuit 70 outputs “1” as the image data to the data line 5 in the odd-numbered column and outputs “0” as the image data to the data line 5 in the even-numbered column when the switch signal xset of “1” is supplied to the data line side erase circuit 70 in the first state. That is, the data line side erase circuit 70 supplies the erase signal that has a pattern selected from a plurality of predetermined erase signal patterns. In addition, the data line side erase circuit 70 outputs “0” as the image data to the data line 5 in the odd-numbered column and outputs “1” as the image data to the data line 5 in the even-numbered column when the switch signal xset of “1” is supplied to the data line side erase circuit 70 in the second state.

The image data that the data line side erase circuit 70 outputs is output to the plurality of data lines 5 (x1, x2, . . . , xm) wired along the X axis direction of the display unit 3. The image data output to the data line 5 is written into the pixel 2 in a column that is selected by the selection signal output from the scan line drive circuit 6.

FIG. 1 is referred to again. The common power supply modulation circuit 8 supplies electrical potentials that serve as a power supply of the pixel circuit in each pixel 2 to a pixel circuit ground line 10 and a pixel circuit power supply line 11 that are used in common in all of the pixel 2. In addition, according to the control of the controller 9, the common power supply modulation circuit 8 supplies electrical potentials that are necessary for driving each pixel 2 to a common electrode power supply line 12, a pixel control line 13, and a pixel control line 14 that are used in common in all of the pixel 2. Electrophoretic particles in each pixel 2 migrate electrophoretically to display a display image in the electrophoretic device 1 in accordance with the image data written into each pixel 2 and electrical potentials supplied to the common electrode power supply line 12, the pixel control line 13, and the pixel control line 14 from the common power supply modulation circuit 8.

Electrical potentials of each of an electrical potential VEP0 supplied to the pixel control line 13 and an electrical potential VEP1 supplied to the pixel control line 14 from the common power supply modulation circuit 8 are switched to be supplied according to the control of the controller 9 so as to change display of each pixel 2 in accordance with the image data written into each pixel 2. In addition, the common power supply modulation circuit 8 may set each of the pixel control line 13 and the pixel control line 14 to be in the high-impedance state (Hi-Z) according to the control of the controller 9 so as to hold the current state of display in each pixel 2.

The electrical potential value of an electrical potential VCOM supplied to the common electrode power supply line 12 from the common power supply modulation circuit 8 is switched to be supplied according to the control of the controller 9 so as to change display of each pixel 2 in accordance with the image data written into each pixel 2. In addition, the common power supply modulation circuit 8 may set the common electrode power supply line 12 to be in the high-impedance state (Hi-Z) according to the control of the controller 9 so as to hold the current state of display in each pixel 2.

The controller 9 controls the operation of each of the scan line drive circuit 6, the scan line side erase circuit 60, the data line drive circuit 7, the data line side erase circuit 70, and the common power supply modulation circuit 8 based on a control signal that is input from a control unit of the electrophoretic device 1 such as an unillustrated central processing unit (CPU) and the like.

Next, the configuration of the pixel circuit in the electrophoretic device 1 of the present embodiment will be described.

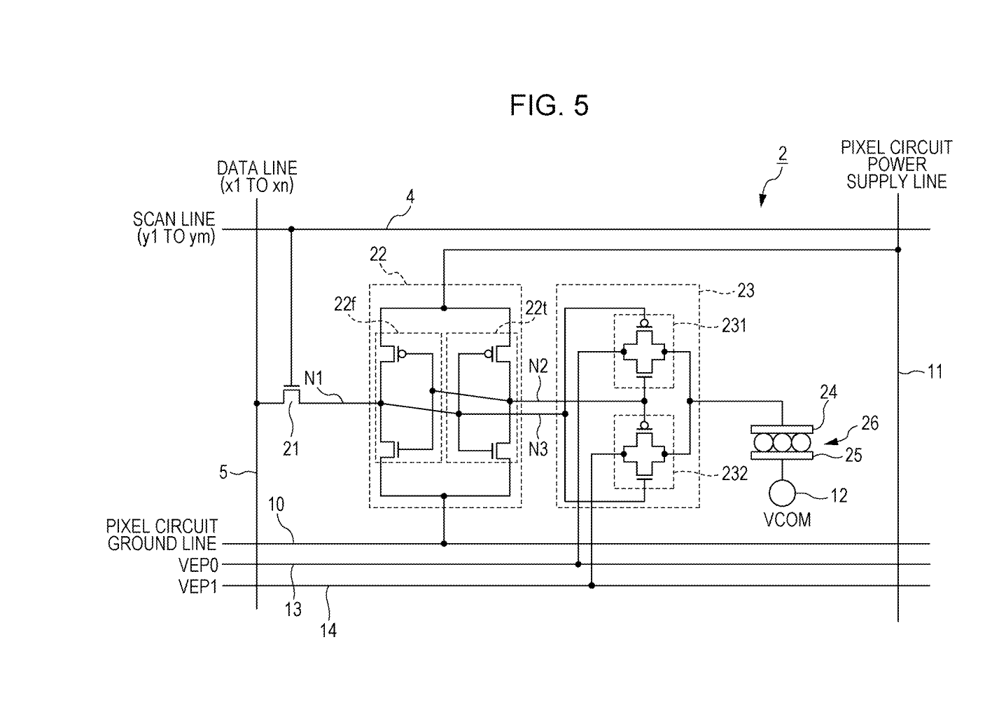

FIG. 5 is a block diagram illustrating an example of the circuit configuration of the pixel 2 of the electrophoretic device 1 in the present embodiment. In FIG. 5, the pixel 2 is configured of a selector transistor (thin film transistor) 21, a latch circuit 22, a switch circuit 23, a pixel electrode 24, a common electrode 25, and an electrophoretic element 26. In addition, the scan line 4, the data line 5, the pixel circuit ground line 10, the pixel circuit power supply line 11, the common electrode power supply 12, the pixel control line 13, and the pixel control line 14 are connected to each pixel 2.

According to the configuration illustrated in FIG. 5, the pixel 2 is configured of nine transistors and is formed to have a so-called nine-transistor (9T) type pixel structure. In addition, the pixel 2 is configured as a static random access memory (SRAM) in which the latch circuit 22 holds electrical potentials of the image data.

The selector transistor 21 is a pixel switching element for selecting the pixel 2 and, for example, is formed of an N-type metal oxide semiconductor (MOS). The scan line 4, the data line 5, and an input terminal N1 of the latch circuit 22 are respectively connected to the gate terminal, the source terminal, and the drain terminal of the selector transistor 21. The selector transistor 21 connects the data line 5 and the latch circuit 22 during the input of the selection signal to the selector transistor 21 from the scan line drive circuit 6 through the scan line 4 to input the image data that is input from the data line drive circuit 7 through the data line 5 to the latch circuit 22.

The latch circuit 22 is a circuit that holds the image data input to the pixel 2 and is configured of a transfer inverter 22t and a feedback inverter 22f that, for example, are formed of a complementary metal oxide semiconductor (CMOS). The pixel circuit power supply line 11 and the pixel circuit ground line 10 are respectively connected to the power supply and the ground terminal of the transfer inverter 22t and the feedback inverter 22f. The transfer inverter 22t and the feedback inverter 22f are formed to have a loop structure in which the output of each one is connected to the input of the other. According to this loop structure, the latch circuit 22 holds the image data that is input to the input terminal of the transfer inverter 22t which is the input terminal N1 of the latch circuit 22 from the data line drive circuit 7 through the selector transistor 21. The output terminal of the transfer inverter 22t and the output terminal of the feedback inverter 22f are connected to the gate terminal of the switch circuit 23 respectively as an output terminal N2 of the latch circuit 22 and an output terminal N3 of the latch circuit 22.

The switch circuit 23 is a selector circuit that selects electrical potentials of the pixel control line 13 or the pixel control line 14 and outputs to the pixel electrode 24 in accordance with the image data of the pixel 2 that is held in the latch circuit 22 and is configured of a transmission gate 231 and a transmission gate 232 that, for example, are formed of a CMOS. The output terminal N2 and the output terminal N3 of the latch circuit 22 each are connected to the gate terminal of the transmission gate 231 and the transmission gate 232. In addition, the pixel control line 13 and the pixel control line 14 are respectively connected to the source terminal of the transmission gate 231 and the source terminal of the transmission gate 232. The drain terminal of the transmission gate 231 and the drain terminal of the transmission gate 232 are collectively connected to the pixel electrode 24.

One of the transmission gate 231 and the transmission gate 232 in the switch circuit 23 is in the ON state in accordance with the image data (“0” or “1”) that is output to the output terminal N2 and the output terminal N3 of the latch circuit 22. Depending on the one which is in the ON state, the electrical potential VEP0 of the pixel control line 13 connected to the transmission gate 231 or the electrical potential VEP1 of the pixel control line 14 connected to the transmission gate 232 is output to the pixel electrode 24.

Here, electrical potentials output to the pixel electrode 24 will be specifically described. The data line drive circuit 7 sets electrical potentials of the data line 5 to “0” when “0” is written as the image data to the pixel 2. The scan line drive circuit 6 selects the pixel 2 using the scan line 4. Accordingly, the selector transistor 21 is in the ON state, and the output of the transfer inverter 22t in the latch circuit 22 is “1”. In addition, the output of the feedback inverter 22f in the latch circuit 22 is a level of “0” according to the output “1” of the transfer inverter 22t, and the output “1” of the transfer inverter 22t is maintained according to the output “0” of the feedback inverter 22f.

In this manner, “0” of the data line 5 is held in the latch circuit 22. The transmission gate 231 is in the ON state, and the transmission gate 232 is in the OFF state according to the “1” of the output terminal N2 of the latch circuit 22 that is the output terminal of the transfer inverter 22t and “0” of the output terminal N3 of the latch circuit 22 that is the output terminal of the feedback inverter 22f. Thus, the electrical potential VEP0 of the pixel control line 13 is output to the pixel electrode 24.

Meanwhile, the data line drive circuit 7 sets electrical potentials of the data line 5 to “1” when “1” is written as the image data to the pixel 2. The scan line drive circuit 6 selects the pixel 2 using the scan line 4. Accordingly, the selector transistor 21 is in the ON state, and the output of the transfer inverter 22t in the latch circuit 22 is “0”. In addition, the output of the feedback inverter 22f in the latch circuit 22 is “1” according to the output “0” of the transfer inverter 22t, and the output “0” of the transfer inverter 22t is maintained according to the output “1” of the feedback inverter 22f.

In this manner, “1” of the data line 5 is held in the latch circuit 22. The transmission gate 231 is in the OFF state, and the transmission gate 232 is in the ON state according to the “0” of the output terminal N2 of the latch circuit 22 that is the output terminal of the transfer inverter 22t and “1” of the output terminal N3 of the latch circuit 22 that is the output terminal of the feedback inverter 22f. Thus, the electrical potential VEP1 of the pixel control line 14 is output to the pixel electrode 24.

That is, the electrical potential VEP0 of the pixel control line 13 is output to the pixel electrode 24 when the image data is “0”, and the electrical potential VEP1 of the pixel control line 14 is output to the pixel electrode 24 when the image data is “1”.

The electrophoretic element 26 is interposed between the pixel electrode 24 and the common electrode 25. The difference in electrical potential between the pixel electrode 24 and the common electrode 25 allows white particles and black particles that are charged in a plurality of microcapsules included in the electrophoretic element 26 to migrate electrophoretically. An image having gradations that correspond to the distance of electrophoretic migration of white particles and black particles is displayed.

The gradations of the image that the pixel 2 displays can be controlled by controlling the direction and the distance of electrophoretic migration of the white particles and the black particles.

Next, the display unit 3 of the electrophoretic device in the present embodiment will be described.

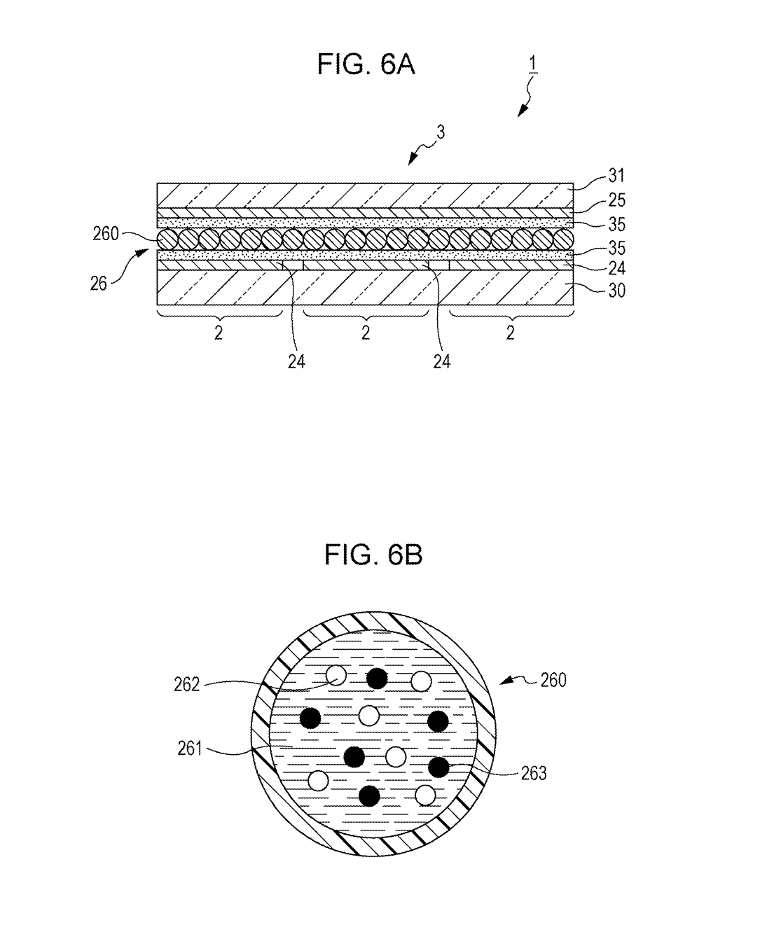

FIGS. 6A and 6B are schematic diagrams illustrating an example of the configuration of the display unit 3 of the electrophoretic device 1 in the present embodiment. FIG. 6A illustrates a cross-sectional diagram of a part of the display unit 3. FIG. 6B illustrates a configuration diagram of the microcapsule.

As illustrated in FIG. 6A, the display unit 3 is configured to interpose the electrophoretic element 26 between an element substrate 30 that includes the pixel electrode 24 and an opposite substrate 31 that includes the common electrode 25. The electrophoretic element 26 is configured of a plurality of microcapsules 260. The electrophoretic element 26 is fixed between the element substrate 30 and the opposite substrate 31 by an adhesive layer 35.

That is, the adhesive layer 35 is formed between the electrophoretic element 26 and the element substrate 30 and between the electrophoretic element 26 and the opposite substrate 31.

The adhesive layer 35 on the element substrate 30 side is necessary for adhesion to the surface of the pixel electrode 24. However, the adhesive layer 35 on the opposite substrate 31 side may not be necessary. This is based on the assumption that only the adhesive layer 35 on the element substrate 30 side may be necessary as an adhesive layer when the common electrode 25, the plurality of microcapsules 260, and the adhesive layer 35 on the opposite substrate 31 side are manufactured in advance for the opposite substrate 31 through an integrated manufacturing process and are treated as an electrophoretic sheet.

The element substrate 30, for example, is a substrate formed of glass, plastic, or the like. The pixel electrode 24 that is rectangularly formed for each pixel 2 is formed on the element substrate 30. Although not illustrated, the scan line 4, the data line 5, the pixel circuit ground line 10, the pixel circuit power supply line 11, the common electrode power supply line 12, the pixel control line 13, the pixel control line 14, the selector transistor 21, the latch circuit 22, the switch circuit 23, and the like that are illustrated in FIG. 1, FIG. 5, and the like are formed in the area between each pixel electrode 24 and on the lower surface of the pixel electrode 24 (a layer on the element substrate 30 side in FIG. 6A).

The opposite substrate 31, for example, is a light-transmissive substrate formed of glass and the like since an image is displayed on the opposite substrate 31 side. Materials that have light transmissivity and conductivity such as magnesium silver (MgAg), indium tin oxide (ITO), indium zinc oxide (IZO, registered trademark), and the like are used in the common electrode 25 formed on the opposite substrate 31.

The electrophoretic element 26 is generally treated as an electrophoretic sheet that is formed in advance on the opposite substrate 31 side and includes the adhesive layer 35. In addition, a protective release paper is attached to the adhesive layer 35 side.

Attaching the electrophoretic sheet with the release paper peeled to the element substrate 30 that is separately manufactured and has the pixel electrode 24, circuits, and the like formed therein forms the display unit 3 in the manufacturing process. For this reason, the adhesive layer 35 is only present on the pixel electrode 24 side in a general configuration.

FIG. 6B is a configuration diagram of the microcapsule 260. The microcapsule 260, for example, has a particle size of approximately 50 μm. The peripheral portion of the microcapsule 260 is formed by using polymeric resins that have light transmissivity such as acrylic resins including polymethyl methacrylate, polyethyl methacrylate, and the like, urea resins, Arabic gum, and the like. The microcapsule 260 is interposed between the common electrode 25 and the pixel electrode 24, and one or more of the microcapsule 260 are arranged vertically and horizontally in one pixel. A binder (not illustrated) that fixes the microcapsule 260 is disposed to fill the space around the microcapsule 260.

A dispersion medium 261 and charged particles of a plurality of white particles 262 and a plurality of black particles 263 as the electrophoretic particles are sealed inside the microcapsule 260.

The dispersion medium 261 is a liquid that disperses the white particle 262 and the black particle 263 in the microcapsule 260.

For example, alcohol-based solvents such as water, methanol, ethanol, isopropanol, butanol, octanol, methyl cellosolve, and the like; various esters such as ethyl acetate, butyl acetate, and the like; ketones such as acetone, methyl ethyl ketone, methyl isobutyl ketone, and the like; aliphatic hydrocarbons such as pentane, hexane, octane, and the like; alicyclic hydrocarbons such as cyclohexane, methylcyclohexane, and the like; aromatic hydrocarbons like benzene that has a long chain alkyl group such as benzene, toluene, xylene, hexylbenzene, butylbenzene, octylbenzene, nonylbenzene, decylbenzene, undecylbenzene, dodecylbenzene, tridecylbenzene, tetradecylbenzene, and the like; halogenated hydrocarbons such as methyl chloride, chloroform, carbon tetrachloride, 1,2-dichloroethane, and the like; carboxylate; other various oil; or mixtures thereof compounded with surfactants can be exemplified as the dispersion medium 261.

The white particle 262, for example, is a particle (polymer or colloid) formed from a white pigment such as titanium dioxide, flowers of zinc, antimony trioxide, and the like and is negatively (minus, −) charged.

The black particle 263, for example, is a particle (polymer or colloid) formed from a black pigment such as aniline black, carbon black, and the like and is positively (plus, +) charged.

For this reason, the white particle 262 and the black particle 263 can move in an electric field that is generated by the difference in electrical potential between the pixel electrode 24 and the common electrode 25 in the dispersion medium 261.

Charge control agents such as electrolytes, surfactants, metal soaps, resins, gum, oil, varnish, compounds, and the like formed from particles; dispersants such as titanium-based coupling agents, aluminum-based coupling agents, silane-based coupling agents, and the like; lubricants; stabilizers; and the like can be added to the above pigments when necessary.

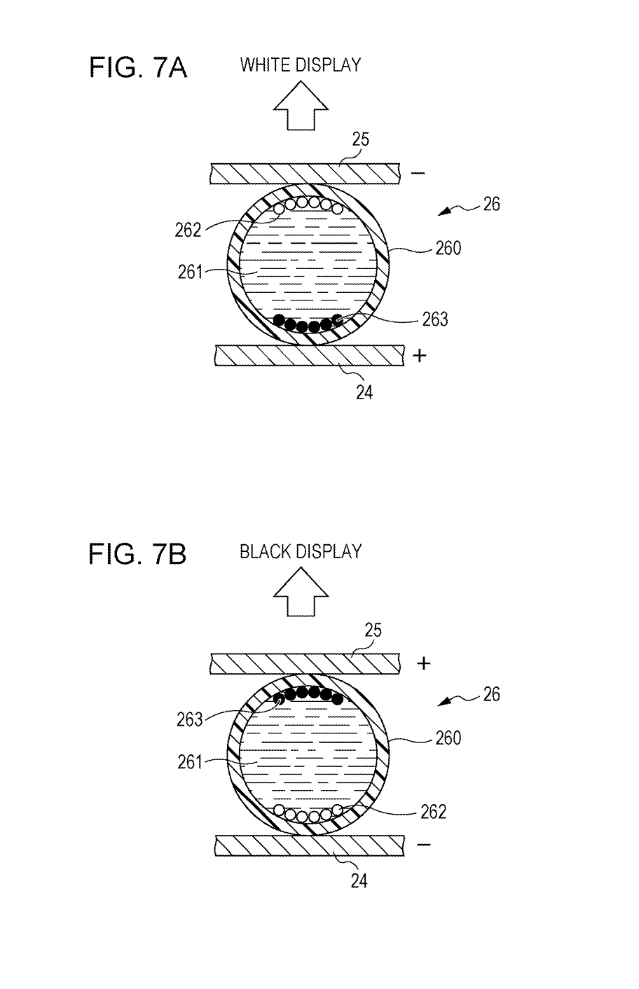

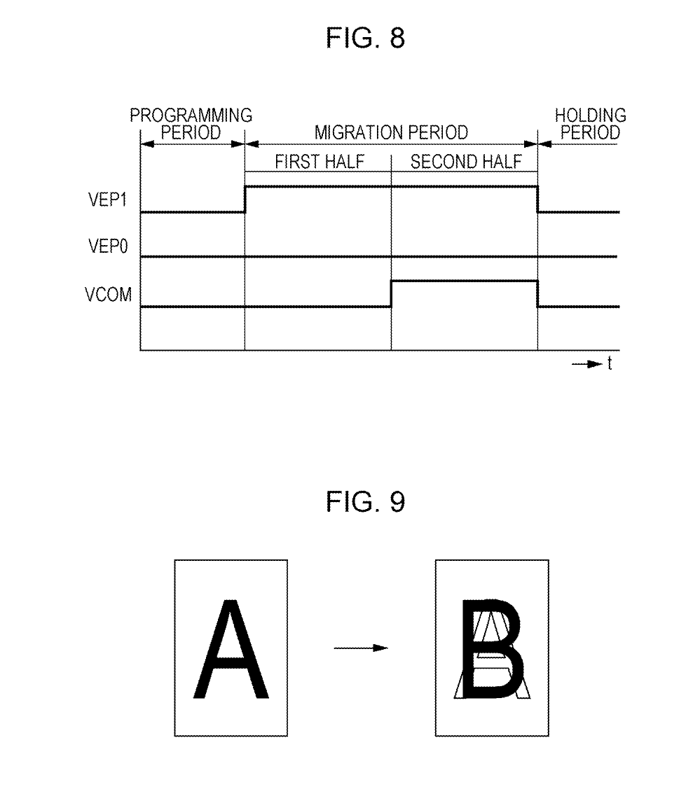

Next, the operation of the electrophoretic element in the electrophoretic device of the present embodiment will be described with reference to FIGS. 7A and 7B and FIG. 8.

FIGS. 7A and 7B are schematic diagrams illustrating an example of the operation of the electrophoretic element 26 in the electrophoretic device 1 of the present embodiment.

FIG. 8 is a timing diagram illustrating an example of the operation of the electrophoretic element 26 in the electrophoretic device 1 of the present embodiment.

FIG. 7A illustrates a case where the pixel 2 displays white, and FIG. 7B illustrates a case where the pixel 2 displays black.

An assumption is made in the description below that the white particle 262 is positively (plus, +) charged, and the black particle 263 is negatively (minus, −) charged.

First, the case where the pixel 2 displays white will be described as illustrated in FIG. 7A. In the present embodiment, the electrical potentials VEP0, VEP1, and VCOM have one of two values of electrical potentials. The higher one of such electrical potentials is described to be “H”, and the lower one is described to be “L” below. In the programming period illustrated in FIG. 8, “1” is written as the image data into the latch circuit 22 of the pixel 2. Accordingly, the transmission gate 231 is in the OFF state, the transmission gate 232 is in the ON state, and the electrical potential VEP1 of the pixel control line 14 is output to the pixel electrode 24.

Next, in the migration period (first half) illustrated in FIG. 8, the electrical potential VEP1 is “H”, and the electrical potential VCOM is “L”. Accordingly, “H” is supplied to the pixel electrode 24, and “L” is supplied to the common electrode 25. As a consequence, the difference occurs in electrical potential between the pixel electrode 24 and the common electrode 25, and the white particle 262 and the black particle 263 electrophoretically migrate respectively to the common electrode 25 side and the pixel electrode 24 side. Thus, the pixel 2 displays white (W) (white display).

Next, in the migration period (second half) illustrated in FIG. 8, “H” of the electrical potential VEP1 is maintained, and the electrical potential VCOM is “H”. In this case, the difference does not occur in electrical potential between the pixel electrode 24 and the common electrode 25. Thus, both the white particle 262 and the black particle 263 do not migrate electrophoretically, and the current state of display is held.

In the case where the pixel 2 displays black as illustrated in FIG. 7B, “0” is written as the image data into the latch circuit 22 of the pixel 2 in the programming period illustrated in FIG. 8. Accordingly, the transmission gate 231 is in the ON state, the transmission gate 232 is in the OFF state, and the electrical potential VEP0 of the pixel control line 13 is output to the pixel electrode 24.

Next, in the migration period (first half) illustrated in FIG. 8, the electrical potential VEP0 is “L”, and the electrical potential VCOM is “L”. In this case, the difference does not occur in electrical potential between the pixel electrode 24 and the common electrode 25. Thus, both the white particle 262 and the black particle 263 do not migrate electrophoretically, and the current state of display is held.

Next, in the migration period (second half) illustrated in FIG. 8, “L” of the electrical potential VEP0 is maintained, and the electrical potential VCOM is “H”. Accordingly, “L” is supplied to the pixel electrode 24, and the high electrical potential “H” is supplied to the common electrode 25. As a consequence, the difference occurs in electrical potential between the pixel electrode 24 and the common electrode 25, and the white particle 262 and the black particle 263 electrophoretically migrate respectively to the pixel electrode 24 side and the common electrode 25 side. Thus, the pixel 2 displays black (B) (black display).

In this manner, the electrophoretic migration of the white particles and the black particles in the electrophoretic element 26 can be controlled by the electrical potential VEP0 of the pixel control line 13 or the electrical potential VEP1 of the pixel control line 14 that is selected on the basis of the image data written into the pixel 2 and is input to the pixel electrode 24 and the electrical potential VCOM of the common electrode power supply line 12 that is input to the common electrode 25.

Hereinafter, as illustrated in FIG. 7A, the operation of displaying white in the pixel 2 by writing the image data into the pixel 2 and setting the electrical potential VCOM of the common electrode 25 to the high electrical potential is referred to as “white writing”. In addition, as illustrated in FIG. 7B, the operation of displaying black in the pixel 2 by writing the image data into the pixel 2 and setting the electrical potential VCOM of the common electrode 25 to the low electrical potential is referred to as “black writing”.

In the migration period in the above example, the first half is a white migration period, and the second half is a black migration period. However, the first half may be the black migration period, and the second half may be the white migration period. Furthermore, the white migration period and the black migration period may be divided into a plurality of small periods, and a small white migration period and a small black migration period may be alternately disposed.

Here, an example of a latent image will be described with reference to FIG. 9.

FIG. 9 is a schematic diagram illustrating an example of a latent image.

As illustrated in FIG. 9, when an image displayed in the display unit 3, for example, is switched from “A” to “B”, a part of the image “A” before switching may be the latent image. The electrophoretic device 1, for example, reduces the latent image by programming the pixel 2 to have a erase pattern of a predetermined form (for example, a checkerboard form or a checker form).

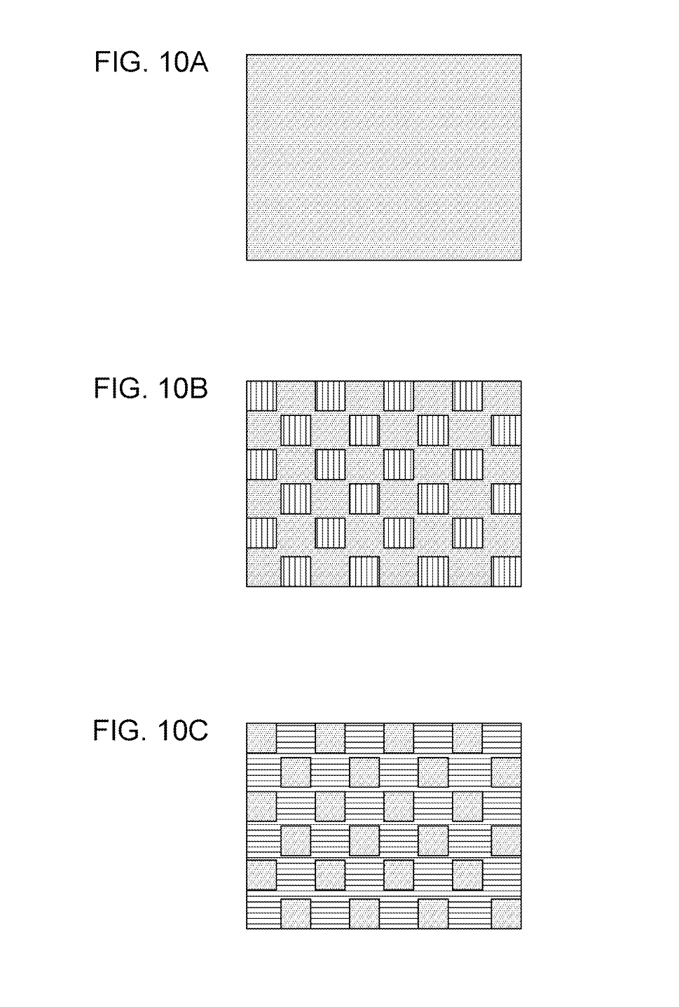

FIGS. 10A to 10C are schematic diagrams illustrating an example of erase by using the erase pattern.

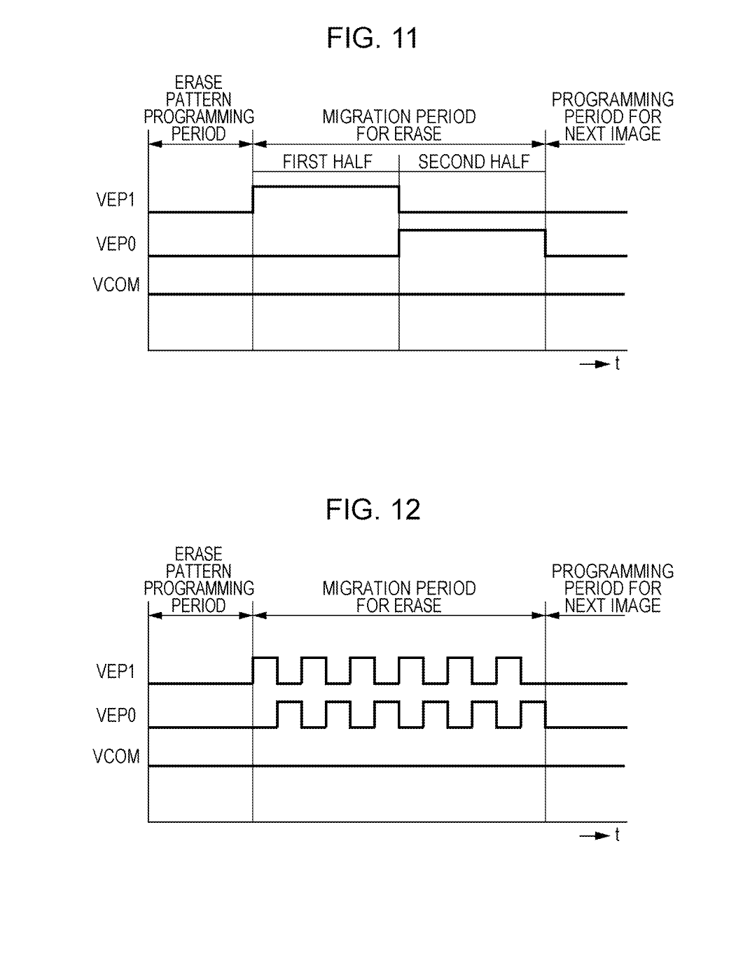

FIG. 10A illustrates an example of an image before switching display. Here, a solid black image will be described as the image before switching display. FIG. 10B illustrates an example of the state of the display image in the first half of the migration period according to the erase pattern. The pixel 2 at the vertically hatched part illustrated in FIG. 10B is changed to display white when the electrophoretic migration is performed according to the erase pattern in the first half of the migration period. FIG. 10C illustrates an example of the state of the display image in the second half of the migration period according to the erase pattern. The pixel 2 at the horizontally hatched part illustrated in FIG. 10C is changed to display white when the electrophoretic migration is performed according to the erase pattern in the second half of the migration period. This example of the operation of the electrophoretic element 26 in accordance with the erase pattern will be described with reference to FIG. 11.

FIG. 11 is a timing diagram illustrating an example of the erase operation of the electrophoretic element 26 in the electrophoretic device 1 of the present embodiment. FIG. 11 illustrates an example of an operation starting at the state illustrated in FIG. 10A where the solid black image is displayed until display of a next image (for example, the image “B” described above). The controller 9 sets the switch signal yenb to “0” in the erase pattern programming period illustrated in FIG. 11. Accordingly, the scan line side erase circuit 60 outputs the voltage that corresponds to the first selection voltage yd1 and the second selection voltage yd2 as the selection signal to the scan line 4. In addition, the controller 9 sets the switch signal xset to “1” in the erase pattern programming period. Accordingly, the data line side erase circuit 70 outputs the voltage that corresponds to the first data voltage xd1 and the second data voltage xd2 as the image data to the data line 5. At this time, the controller 9 sequentially switches “1” and “0” for the first selection voltage yd1 and the second selection voltage yd2, and the first data voltage xd1 and the second data voltage xd2. Accordingly, the pixel 2 programmed to have the high electrical potential and the pixel 2 programmed to have the low electrical potential are alternately arranged as the pixel 2, and the pixel 2 is programmed to have the erase pattern of a checkerboard form (checker form).

Next, in the migration period for erase (first half) illustrated in FIG. 11, the electrical potential VEP0 is “L” (low electrical potential), the electrical potential VEP1 is “H” (high electrical potential), and the electrical potential VCOM is “L”. Accordingly, “L” is supplied to the pixel electrode 24 for each pixel 2 that is programmed to have “0”, “H” is supplied to the pixel electrode 24 for each pixel 2 that is programmed to have “1”, and “L” is supplied to the common electrode 25. As a consequence, the difference occurs in electrical potential between the pixel electrode 24 and the common electrode 25 for each pixel 2 that is programmed to have “1”, and the white particle 262 and the black particle 263 electrophoretically migrate respectively to the common electrode 25 side and the pixel electrode 24 side. Thus, the pixel 2 displays white (W) (white display) as illustrated in FIG. 10B. Meanwhile, the difference does not occur in electrical potential between the pixel electrode 24 and the common electrode 25 for each pixel 2 that is programmed to have “0”. Thus, the state of display does not change.

Next, in the migration period for erase (second half) illustrated in FIG. 11, the electrical potential VEP0 is “H”, the electrical potential VEP1 is “L”, and the electrical potential VCOM is “L”. Accordingly, “H” is supplied to the pixel electrode 24 for each pixel 2 that is programmed to have “0”, and “L” is supplied to the common electrode 25. As a consequence, the difference occurs in electrical potential between the pixel electrode 24 and the common electrode 25 for each pixel 2 that is programmed to have “0”, and the white particle 262 and the black particle 263 electrophoretically migrate respectively to the common electrode 25 side and the pixel electrode 24 side. Thus, the pixel 2 displays white (W) (white display) as illustrated in FIG. 10C. Accordingly, the electrophoretic device 1 sets all of the pixels 2 to display white and excludes charged particles and the like that remain between the electrodes or the like of the pixel 2. Thus, the electrophoretic device 1 can reduce (erase) the latent image.

After performing the migration for erase according to the erase pattern in this manner, the controller 9 programs the pixel 2 for the next image (for example, the image “B” described above) in the programming period for the next image.

The migration period for erase is exemplified as being divided into the first half and the second half, but this does not limit the migration period. For example, the operation in the migration period for erase may be performed in the manner illustrated in FIG. 12.

FIG. 12 is a timing diagram illustrating a modification example of the erase operation of the electrophoretic element 26 in the electrophoretic device 1 of the present embodiment.

As illustrated in FIG. 12, the controller 9 may divide the migration period for erase into a period for setting the electrical potential VEP0 to the high electrical potential and a period for setting the electrical potential VEP1 to the high electrical potential and dispose alternately. Even in this manner, the electrophoretic device 1 sets all of the pixels 2 to display white and excludes charged particles and the like that remain between the electrodes or the like of the pixel 2. Thus, the electrophoretic device 1 can reduce (erase) the latent image.

In addition, the controller 9 may dispose a period in which both of the electrical potential VEP0 and the electrical potential VEP1 are set to the high electrical potential to allow the pixel 2 to display white. Furthermore, the controller 9 may dispose the period in which both of the electrical potential VEP0 and the electrical potential VEP1 are set to the high electrical potential to allow the pixel 2 to display white at an arbitrary timing and an arbitrary number of times.

As described hereinbefore, the electrophoretic device 1 programs the pixel 2 to have the erase pattern using the scan line side erase circuit 60 and the data line side erase circuit 70. Here, when the electrophoretic device 1 does not include the scan line side erase circuit 60 and the data line side erase circuit 70, the electrophoretic device 1 adopts the manner below to program the pixel 2 to have the erase pattern. That is, the electrophoretic device 1 programs the pixel 2 to have the erase pattern by allowing each of the scan line drive circuit 6 and the data line drive circuit 7 to perform a shift operation. In this case, the voltage level changes a number of times that corresponds to the number of scan lines 4 (for example, m times) since the pixel 2 is programmed to have the erase pattern while being scanned. Here, parasitic capacitance occurs in the line of the shift clock signal for the shift operation and in the data line. Thus, power is consumed due to the change in the voltage level. That is, power is consumed corresponding to the number of scans when the electrophoretic device 1 programs the pixel 2 to have the erase pattern by scanning using the scan line drive circuit 6 and the data line drive circuit 7.

Meanwhile, the electrophoretic device 1 in the present embodiment programs the pixel 2 to have the erase pattern using the scan line side erase circuit 60 and the data line side erase circuit 70. Thus, the number of changes in the voltage level can be decreased compared with the above case where the pixel 2 is programmed to have the erase pattern by scanning. Accordingly, the electrophoretic device 1 in the present embodiment can reduce the power consumption compared with the above case where the pixel 2 is programmed to have the erase pattern by scanning.

Specifically, given that energy that is necessary for one time of the erase operation on the latent image is one in a case of using a QVGA (having a diagonal size of 3.5 cm) electrophoretic element panel in which a low-temperature polysilicon substrate is used, energy that is necessary for programming is approximately 0.8, and energy for moving the electrophoretic element is approximately 0.2. That is, most of the energy for rewriting is used as the energy that is necessary for programming. The electrophoretic device 1 in the present embodiment can use substantially zero of energy for programming the pixel 2 to have the erase pattern. Thus, the energy that is necessary for one time of the erase operation on the latent image is approximately 0.2. That is, the energy that is necessary for the erase of the latent image can be reduced by 80 percent according to the electrophoretic device 1 in the present embodiment.

In addition, the electrophoretic device 1 in the present embodiment programs the pixel 2 at the same time to have the erase pattern using the scan line side erase circuit 60 and the data line side erase circuit 70, not programming by scanning. Thus, the programming period can be shortened.

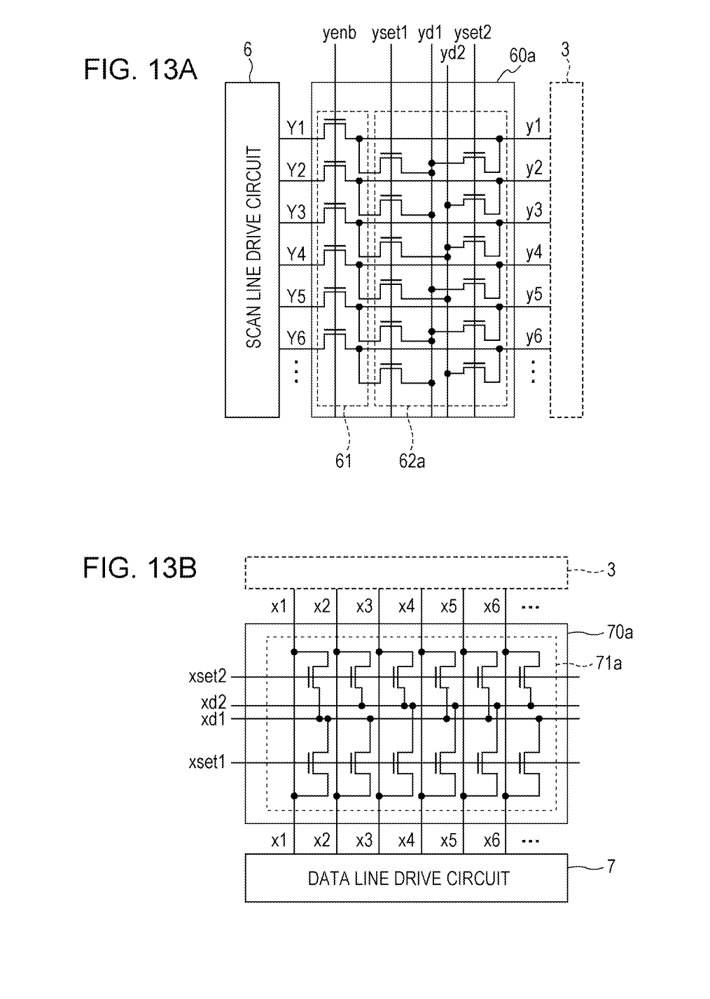

In the description hereinbefore, the scan line side erase circuit 60 and the data line side erase circuit 70 are described as programming the pixel 2 to have the erase pattern of a one-pixel-unit checkerboard form (checker form), but this does not limit the scan line side erase circuit 60 and the data line side erase circuit 70. For example, the odd-numbered pixels are programmed to have the image data “1” by setting the switch signal yenb to “0”, the first selection voltage yd1 to “1”, the second selection voltage yd2 to “0”, the switch signal xset to “1”, the first data voltage xd1 to “1”, and the second data voltage xd2 to “1”. Then, the even-numbered pixels may be programmed to have the image data “0” by setting the switch signal yenb to “0”, the first selection voltage yd1 to “0”, the second selection voltage yd2 to “1”, the switch signal xset to “1”, the first data voltage xd1 to “0”, and the second data voltage xd2 to “0”, thus programming the pixel 2 to have the image data of horizontal stripes for erase. Alternatively, the odd-numbered pixels may be programmed to have the image data “1”, and the even-numbered pixels may be programmed to have the image data “0” by setting the switch signal yenb to “0”, the first selection voltage yd1 to “1”, the second selection voltage yd2 to “1”, the switch signal xset to “1”, the first data voltage xd1 to “1”, and the second data voltage xd2 to “0” as the image data of vertical stripes for erase. In addition, the scan line side erase circuit 60 and the data line side erase circuit 70 may be configured in other manners than that as described above. One example is illustrated in FIGS. 13A and 13B.

FIGS. 13A and 13B are block diagrams illustrating an example of the circuit configuration of a scan line side erase circuit 60a and a data line side erase circuit 70a. The scan line side erase circuit 60a includes the first transistor 61 and a second transistor 62a. The second transistor 62a programs the pixel 2 for rows in the erase pattern of a two-pixel-unit checkerboard form (checker form). The second transistor 62a is connected to the supply line of the first selection voltage yd1 or the supply line of the second selection voltage yd2 and is connected to the scan lines 4 (y1 to ym). In addition, the second transistor 62a is connected to a first switch signal yset1 and a second switch signal yset2 instead of being connected to the switch signal yenb. Both the first switch signal yset1 and the second switch signal yset2 are connected to the controller 9. The controller 9 selects a row of a target that is programmed to have the erase pattern by changing each voltage of the first switch signal yset1 and the second switch signal yset2 to the high electrical potential or the low electrical potential.

The data line side erase circuit 70a includes a switch transistor 71a. The switch transistor 71a programs the pixel 2 for columns in the erase pattern of a two-pixel-unit checkerboard form (checker form). The switch transistor 71a is connected to the supply line of the first data voltage xd1 or the second data voltage xd2 and is connected to the data lines 5 (x1 to xn). In addition, the switch transistor 71a is connected to a first switch signal xset1 and a second switch signal xset2 instead of being connected to the switch signal xset. Both the first switch signal xset1 and the second switch signal xset2 are connected to the controller 9. The controller 9 selects a column of the target that is programmed to have the erase pattern by changing each voltage of the first switch signal xset1 and the second switch signal xset2 to the high electrical potential or the low electrical potential.

Regarding the rows, the controller 9, for example, selects rows one, two, five, six, . . . by setting the first switch signal yset1 to the high electrical potential, the second switch signal yset2 to the low electrical potential, the first selection voltage yd1 to the high electrical potential, and the second selection voltage yd2 to the low electrical potential. At this time, regarding the columns, the controller 9 programs the pixel 2 in columns one, two, five, six, . . . in rows one, two, five, six, . . . to have the high electrical potential and programs the pixel 2 in other columns in the same rows to have the low electrical potential by setting the first switch signal xset1 to the high electrical potential and the second switch signal xset2 to the low electrical potential. In addition, regarding the rows, the controller 9 selects rows three, four, seven, eight, . . . by setting the first selection voltage yd1 to the low electrical potential and the second selection voltage yd2 to the high electrical potential. At this time, regarding the columns, the controller 9 programs the pixel 2 in columns one, two, five, six, . . . in rows three, four, seven, eight, . . . to have the low electrical potential and programs the pixel 2 in other columns in the same rows to have the high electrical potential by setting the first switch signal xset1 to the low electrical potential and the second switch signal xset2 to the high electrical potential. In this manner, the controller 9 programs the pixel 2 to have the erase pattern of a two-pixel-unit checkerboard form (checker form).

The controller 9 can further program the pixel 2 to have the erase pattern of a phase-shifted two-pixel-unit checkerboard form (checker form) after performing the migration operation for erase using the above erase pattern. For example, the controller 9 selects rows and columns in the same manner as described above by setting the first switch signal yset1 to the low electrical potential and the second switch signal yset2 to the high electrical potential. The electrophoretic device 1 can increase the erase ratio of the latent image by performing the migration operation for erase using the erase pattern of the phase-shifted checkerboard form (checker form). In addition, the electrophoretic device 1 can reduce the power consumption compared with the above case where the pixel 2 is programmed to have the erase pattern by scanning.

### Electronic Apparatus

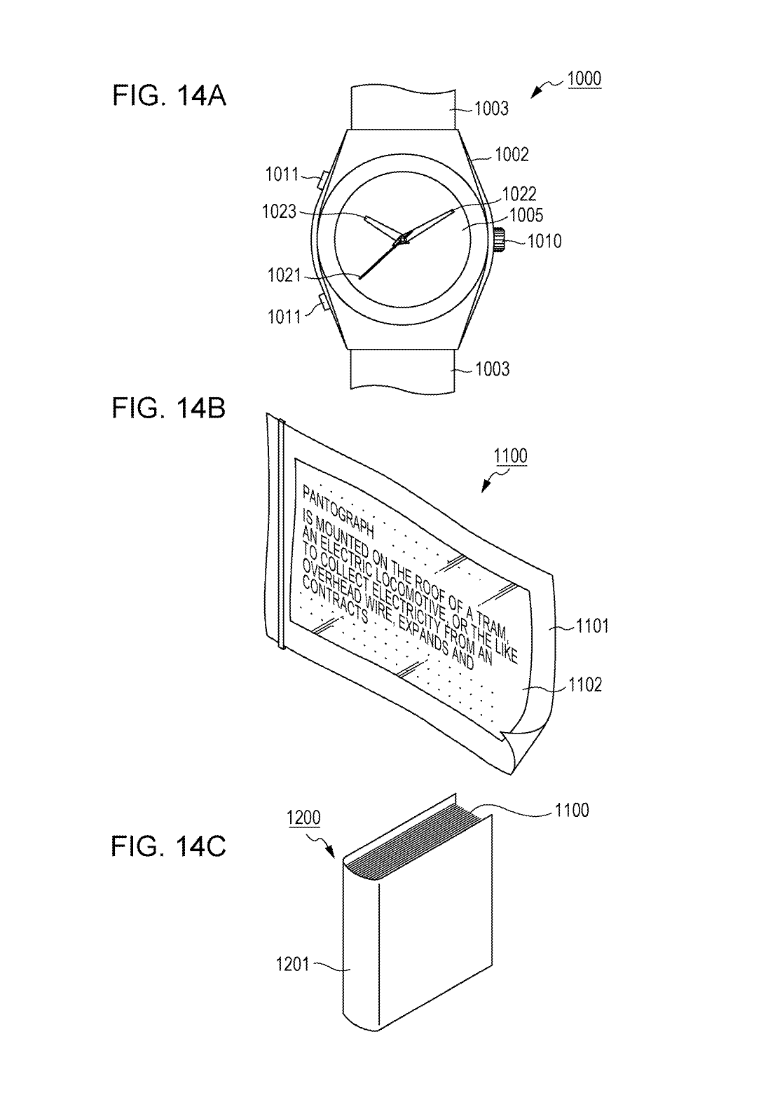

Next, a case where the electrophoretic device in the invention is applied to an electronic apparatus will be described. FIGS. 14A to 14C are diagrams illustrating an example of the electronic apparatus to which the electrophoretic device 1 in the present embodiment is applied.

FIG. 14A is a front view of a wristwatch 1000 that is an example of the electronic apparatus. The wristwatch 1000 includes a watch case 1002 and a pair of bands 1003 that is connected to the watch case 1002.

A display unit 1005 that is formed of the electrophoretic device in the invention, a second hand 1021, a minute hand 1022, and an hour hand 1023 are disposed on the front surface of the watch case 1002. A crown 1010 and operational buttons 1011 are disposed on the side surface of the watch case 1002. The crown 1010 is connected to a winding stem (not illustrated) that is disposed inside the case. Integrated with the winding stem, the crown 1010 is disposed to be capable of being pushed or pulled in a multilevel manner (for example, a two-level manner) and being rotated.

Images as a background; character strings such as a date, a time, and the like; or the second hand, the minute hand, the hour hand, and the like can be displayed in the display unit 1005 according to the method of driving the electrophoretic device in the invention.

Providing the wristwatch 1000 with the electrophoretic device in the invention as the display unit 1005 allows display rewriting to be seen as being performed simultaneously, thus enabling the wristwatch 1000 to display optimally.

FIG. 14B is a perspective view illustrating the configuration of an electronic paper 1100. The electronic paper 1100 is flexible and includes a main body 1101 that is formed of a rewritable sheet having the same texture and pliability as those of a paper in the related art and a display unit 1102 that is formed of the electrophoretic device in the invention. The electronic paper 1100 optimally rewrites display according to the method of driving the electrophoretic device in the invention.

FIG. 14C is a perspective view illustrating an electronic notebook 1200 that is an example of the electronic apparatus. The electronic notebook 1200 is formed of a cover 1201 and a plurality of electronic papers 1100 illustrated in FIG. 14B that is interposed in the cover 1201. The cover 1201, for example, includes a display data input unit (not illustrated) that inputs display data transferred from external devices. Accordingly, the display contents can be changed or updated according to the display data while the electronic paper remains bound.

Providing the electronic paper 1100 and the electronic notebook 1200 with the electrophoretic device in the invention allows display rewriting to be seen as being performed simultaneously, thus enabling the electronic paper 1100 and the electronic notebook 1200 to display optimally.

The electronic apparatus illustrated in FIGS. 14A to 14C are illustrations of the electronic apparatus according to the invention and do not limit the technical range of the invention. Besides the electronic paper 1100 and the electronic notebook 1200, the electrophoretic device according to the invention can be preferably used in a display area of an electronic apparatus such as cell phones, portable audio devices, and the like.

Accordingly, display rewriting can be seen as being performed simultaneously, thus enabling the electronic apparatus to display optimally.

According to the embodiment of the invention, as described above, the scan line side erase circuit 60 and the data line side erase circuit 70 programs the pixel 2 to have the erase pattern. Thus, the number of changes in the voltage level can be decreased compared with the case where the pixel 2 is programmed to have the erase pattern by scanning. As a consequence, the electrophoretic device 1 can reduce the power consumption compared with the above case where the pixel 2 is programmed to have the erase pattern by scanning.

In the present embodiment, the case where the white particle 262 and the black particle 263 are respectively charged positively (plus, +) and negatively (minus, −) is described. However, not limited to the present embodiment, a case where the white particle 262 and the black particle 263 have reverse polarity, that is, the white particle 262 and the black particle 263 are respectively charged negatively (minus, −) and positively (plus, +) can also be regarded in the same manner as in the present embodiment.

In addition, in the present embodiment, the electrophoretic device 1 is described as displaying two states of white display and black display or gray (also including dark gray (DG): dense gray and light gray (LG): sparse gray) that is a medium gradation between white and black using the white particle 262 and the black particle 263, that is, displaying a so-called monochrome display. However, not limited to the present embodiment, the drive method in the invention, for example, can also be applied to an electrophoretic device that can display red, green, blue, and the like by replacing the pigment used in the white particle 262 and the black particle 263 with pigments of red, green, blue, and the like.

In addition, in the present embodiment, the case where the state of the electrical potentials of the pixel electrode 24 in the pixel 2 is set to be simultaneously two states by inputting any one of the electrical potential VEP0 of the pixel control line 13 and the electrical potential VEP1 of the pixel control line 14 to the pixel electrode 24 is described. However, not limited to the present embodiment, the drive method in the invention, for example, can also be applied to a pixel that is configured to be capable of setting the state of the electrical potentials of a pixel electrode in the pixel to be simultaneously a plurality of states such as “L” (low electrical potentials or a “Low” level), “H” (high electrical potentials or a “High” level), the high-impedance state (Hi-Z), a state in phase with the electrical potential VCOM, a state out of phase with the electrical potential VCOM, and the like by using a plurality of pixel control lines.

In addition, in the present embodiment, the electrophoretic device 1 is described as having a nine-transistor (9T) type pixel structure. However, not limited to the present embodiment, the drive method in the invention can also be applied to the electrophoretic device 1 that has a so-called one-transistor one-capacitor (1T1C) type pixel structure.

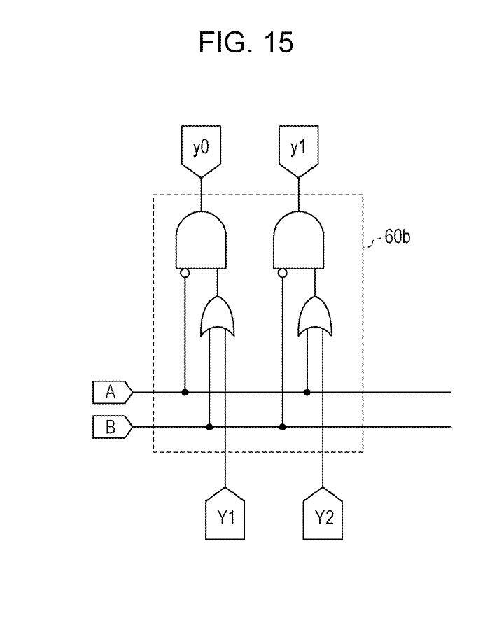

In addition, in the present embodiment, the scan line side erase circuit 60 and the data line side erase circuit 70 are described as supplying the erase signal of a pattern that is selected from a plurality of predetermined patterns of the erase signal to perform the migration operation for erase. However, not limited to the present embodiment, the electrophoretic device 1, for example, may generate the erase pattern using a logic circuit and perform the migration operation for erase according to the erase pattern generated as illustrated in FIG. 15.

That is, the electrophoretic device 1 includes a scan line side erase circuit 60b. The scan line side erase circuit 60b is a logic circuit of which an output value is determined by a control signal A and a control signal B. The controller 9 outputs the control signal A and the control signal B. Based on the control signal A and the control signal B that the controller 9 outputs, the scan line side erase circuit 60b determines the output value according to the arithmetic operations shown in Expression 1 and Expression 2.

y0=/A·(B+Y0) (1)

y1=/B·(A+Y1) (2)

Here, input values (Y0 and Y1) are output without change as the value of the scan lines (y0 and y1) when all of the control signal A and the control signal B are set to zero (low electrical potential). Meanwhile, when one of the control signal A and the control signal B is set to zero (low electrical potential), and the other is set to one (high electrical potential), the odd-numbered row of the scan lines can be set to one (or zero), and the even-numbered row can be set to zero (or one). Such a configuration can decrease the size of the scan line side erase circuit 60b.

The data line side erase circuit 70 can also be configured by a logic circuit in the same manner as the scan line side erase circuit 60b.

### Summarization of Embodiment Hereinbefore

Hereinbefore, the embodiment of the invention is described in detail with reference to the accompanying drawings. However, specific configurations of the invention are not limited to the embodiment and also include designs and the like within the range not departing from the gist of the invention.

A program for realizing functions of any constituents in the device described hereinbefore may be recorded in a computer-readable recording medium and read into a computer system to be executed. The “computer system” referred hereto is assumed to include an operating system (OS) and hardware such as peripherals and the like. The “computer-readable recording medium” refers to a portable medium such as a flexible disk, a magneto-optical disc, a read-only memory (ROM), a compact disk (CD)-ROM, and the like or a storage device such as a hard disk and the like incorporated into the computer system. The “computer-readable recording medium” further includes a medium that holds a program for a certain time such as a volatile memory (random access memory, RAM) inside the computer system which serves as a server or a client when the program is transferred through a network such as the Internet and the like or through a communication channel such as a telephone channel and the like.

The above program may be transferred to another computer system from the computer system of which the program is stored in a storage device or the like via a transfer medium or by a transfer wave in a transfer medium. Here, the “transfer medium” that transfers the program refers to a medium that has a function of transferring information such as a network (communication network) including the Internet and the like and a communication channel (communication line) including a telephone channel and the like.

In addition, the above program may be a program for realizing a part of the functions described above. Furthermore, the above program may be a program that can realize the above-described functions in combination with another program stored in advance in the computer system, that is, a so-called differential file (differential program).

The entire disclosure of Japanese Patent Application No. 2014-058984, filed Mar. 20, 2014 is expressly incorporated by reference herein.

What is claimed is:

1. An electrophoretic device comprising:
a pixel that includes
a first electrode and a second electrode which is opposite the first electrode,
an electrophoretic element which is interposed between the first electrode and the second electrode and includes charged electrophoretic particles, and
a pixel circuit which applies a difference in electrical potential between the first electrode and the second electrode;
a scan line and a data line that are connected to the pixel circuit; and
a first erase circuit that is arranged in a non-display area of the pixel and is a circuit which is connected to the scan line and supplies a erase signal of the pixel to the scan line.

2. An electrophoretic device comprising:
a pixel that includes
a first electrode and a second electrode which is opposite the first electrode,
an electrophoretic element which is interposed between the first electrode and the second electrode and includes charged electrophoretic particles, and
a pixel circuit which applies a difference in electrical potential between the first electrode and the second electrode;
a scan line and a data line that are connected to the pixel circuit; and
a second erase circuit that is arranged in a non-display area of the pixel and is a circuit which is connected to the data line and supplies a erase signal of the pixel to the data line.

3. The electrophoretic device according to claim 1,
wherein the first erase circuit includes a first erase signal supply line that is connected to each scan line and is a signal supply line of which the number corresponds to the number of scan lines.

4. The electrophoretic device according to claim 2,
wherein the second erase circuit includes a second erase signal supply line that is connected to each data line and is a signal supply line of which the number corresponds to the number of data lines.

5. The electrophoretic device according to claim 1,
wherein the first erase circuit supplies the erase signal of a pattern that is selected from a plurality of predetermined patterns of the erase signal.

6. The electrophoretic device according to claim 2,
wherein the second erase circuit supplies the erase signal of a pattern that is selected from a plurality of predetermined patterns of the erase signal.

7. The electrophoretic device according to claim 1,
wherein the first erase circuit generates a pattern of the erase signal and supplies the pattern of the erase signal generated.

8. The electrophoretic device according to claim 1,
wherein the second erase circuit generates a pattern of the erase signal and supplies the pattern of the erase signal generated.

9. An electronic apparatus comprising:
the electrophoretic device according to claim 1.

10. An electronic apparatus comprising:
the electrophoretic device according to claim 2.

11. An electronic apparatus comprising:
the electrophoretic device according to claim 3.

12. An electronic apparatus comprising:
the electrophoretic device according to claim 4.

13. An electronic apparatus comprising:
the electrophoretic device according to claim 5.

14. An electronic apparatus comprising:
the electrophoretic device according to claim 6.

15. An electronic apparatus comprising:
the electrophoretic device according to claim 7.

16. An electronic apparatus comprising:
the electrophoretic device according to claim 8.
